(19) United States
(12) Patent Application Publication
(10) Pub. No.: US 2013/0225012 A1
(43) Pub. Date: Aug. 29, 2013

(54) ELECTRICAL POWER DISTRIBUTION TRACK SYSTEM

(71) Applicants: Lip-Sing Leng, Singapore (SG); It-Seng Leng, Singapore (SG)

(72) Inventors: Lip-Sing Leng, Singapore (SG); It-Seng Leng, Singapore (SG)

(21) Appl. No.: 13/810,433

(22) PCT Filed: Jul. 15, 2010
(86) PCT No.: PCT/SG2010/000267

§ 371 Date: May 10, 2013

(51) Int. Cl. H01R 9/26

(52) U.S. Cl. CPC H01R 9/2691
USPC 439/716

(57) ABSTRACT

An electrical power distribution housing (100) has an elongate opening (104) intended to allow the adapters/plugs (1400) to be inserted to receive electrical power at any point along the housing. A springleaf assembly (300) is mounted adjacent to the elongate opening (104) and extend to close the elongate opening (104) during a non-use situation. A safety grounding plate (200) is mounted on top of the springleaf assembly (300). Power conductors comprising multiple clips (402) are mounted conductor compartments (102) within the housing (100). When an adapter/plug (1400) is inserted into the housing (100) through the elongate opening (104), limbs (1001) will force the corresponding springleaf (301) to open by flexing it onto a springleaf profile (101). The adapter/plug (1400) rotates to “closed” position to slide a contact (807) into engagement with a corresponding contact (402) of the power conductor. When the adapter/plug (1400) rotates to an “open” position and is removed from the elongate opening (104), the corresponding springleaf (301) will return and to close the elongate opening (104).

This invention relates generally to an improvement of the electrical power distribution system which includes a housing with an elongate connection opening to allow the connectable adapters/plugs to connect at any point along the electrical power distribution track system.

### BACKGROUND

Conventional power distribution wiring power distribution systems are inflexible, requiring pre-routed wiring and pre-assign power outlet locations. Any alternation to the distribution system, such as the addition of an outlet after the initial installation is inconvenient and costly to the user.

Bus systems with an elongate housing and an elongate opening, covering conductors which run inside the housing along its entire length, allow a power outlet to be connected at any point along the rail. Such systems allow greater flexibility for the addition of outlets, however they create a major safety concern because foreign objects are easily inserted into the elongate opening creating a danger of electric shock.

### SUMMARY

According to one aspect of the invention, an electrical power distribution shuttering system is provided comprising:
i) an elongate housing (100);
ii) an elongate opening (104) through a surface of the housing, the opening intended to allow an adapter/plug (1400) to be inserted into the housing in use;
iii) one or more springleaf assembly mounting surfaces (107) extending longitudinally of the elongate housing;
iv) a resilient elongate springleaf assembly (300) mounted to the housing (100) on each springleaf assembly mounting surface (107) and extending to cover the elongate opening (104).

In an embodiment of the invention a conductive elongate safety grounding plate (200) may be mounted over the springleaf assemblies (300).

A springleaf profile (101) may be formed adjacent to the elongate opening (104), between the elongate opening (104) and each springleaf assembly mounting surface (107), and the springleaf profile (101) may curve into the opening and have a curvature matched to an elastic characteristic of the springleaf (301).

Each resilient elongate springleaf assembly (300) may be formed from a conductive resilient sheet material such as spring steel sheet and may also be divided into a plurality of springleafs (301) by slits extending from an edge of a springleaf plate (303). The other edge (309) of the springleaf plate (303) may be bent to an angle intended to prevent the springleaf assembly (300) being pulled out during the insertion of the adapter/plug (1400). The springleaf assembly (300) may comprise multiple springleaf plates (303) assembled with pairs of elongate mounting plates (305) which may be formed as plastic extrusions and between which the springleaf plate(s) (303) may be laminated and secured with adhesive (304).

The safety grounding plates (200) may be connected to the AC ground by wires via the grounding screw (201) and grounding nut (203).

According to another aspect a power distribution system is provided comprising:
i) a plurality of contacts (402) formed from conductive spring material;
ii) two or more elongate conductive track plates (500), to each of which a plurality of the contacts (402) are mounted and are electrically connected;
iii) two or more elongate insulated track holders (600) into each of which one of the conductive track plates (500) and the respective mounted contacts (402) are assembled;
iv) a housing (100) having an elongate opening (104);
v) a cavity comprising two or more elongate compartments (102) formed in the housing (100) adjacent to the elongate opening (104), each of the assemblies of the elongate insulated track holders (600) the conductive track plates (500) and the respective mounted contacts (402) being mounted into one of the compartments (102), there being one compartment (102) and one assembly of an elongate insulated track holder (600), conductive track plate (500) and respective mounted contacts (402) for each electrical phase to be delivered via the power distribution system.

The contacts (402) may be formed as an elongate contact strip (400) from which the contacts (402) project and each track holder (600) may be formed as an extrusion of an insulating plastics material.

The power distribution system may be arranged such that in use an electrical connector (800) of an adapter/plug (1400) can be inserted through the elongate opening (104) in the housing (100) and rotated from an “open” or disconnected position to a “closed” or connected position in which the connector (800) engages with respective ones of the contacts (402) to enable power supplied to the connector (800) after installation to be delivered to the adapter/plug (1400), and the electrical connector (800) may comprise two exposed contacts (807) each located at an end of a respective arm arranged to form an electrical connection with a corresponding contact (402) by sliding engagement during the rotation to the “closed” position.

According to yet another aspect of the invention an adapter/plug grounding system for an adapter/plug (1400) of an electrical power distribution system is provided, the grounding system comprising:
i) a bottom cover (900) of the adapter/plug (1400);
ii) a safety protector guide (901) projecting from the bottom cover (900) and extending around an edge of an opening (902) therein;
iii) a safety protector (1000) seated in the safety protector guide (901) and able to rotate therein, the safety protector (1000) being formed of conductive material and comprising a round rotatable plate (1006) located in the protector guide (901), round rotatable plate (1006) having a centre hole, at least one rotatable groove (1003) formed on an internal surface (1008) of the round rotatable plate (1006); and at least one limb (1001) extending from an exposed surface (1007) of the round rotatable plate (1006) opposite the internal surface (1008);
iv) a ground connector (1200) and ball contact (1201) which travels in the groove (1003) during the rotation from the “open” position to “closed” position;
v) an adapter plate (1000) seated on the safety protector (1000) inside the bottom cover (900), the adapter plate having connector block (1101) having an opening in which the ground connector (1200) and ball contact (1201) are located and being held in contact with the groove (1003) by a spring (1202).

The safety protector (1000) may comprise detents (1004) at each end of the groove (1003) to produce an indication sound and provide retention when the safety protector (1000) is rotated to the “open” or “closed” position.

The safety protector (1000) is movable axially, prior to insertion of the adapter (1400) into the housing (100), and the safety protector (1000) preferably biased into an extended position by the springs (1202) such that the exposed surface (1007) projects out of the bottom cover (900).

When in use, the adapter/plug (1400) may be inserted into the opening (104) of a power track, and the adapter/plug (1400) may be prevented from rotating until the exposed surface (1007) has been pushed back towards the bottom cover (900), allowing the connector (800) to be fully inserted until the bottom arm of the connector (800) has passed through the opening (104) and fully into the cavity (102). Grounding of the ground connector (1200) of the adapter/plug (1400) is achieved by strong contact of the exposed surface (1007) with the safety grounding plate (200). This safety lock-out feature ensures that the adapter/plug (1400) is firmly grounded before it may be rotated to the “closed” position where electrical connection is made with the mains conductors.

The safety protector guide (901) preferably includes a gap in which a stopper (1002) projecting from the safety protector (1000) is located to prevent rotation of the safety protector (1000) beyond the “open” and “closed” positions.

According to another aspect an adapter/plug (1400) for an electrical power distribution system the adapter/plug (1400) is provided comprising a rotatable connector arm (806), for connection of the adapter/plug to power conductor contacts of the electrical power distribution system, a connection plate (801) of the connector arm (806) being formed from conductive material and having a tapered edge to increase an electrical dielectric strength of an assembly containing the connector (800).

The connector arm (806) may comprises one or more contact plates (803) formed of conductive material and attached to the connector plate (801) to form a contact (807) having an increased thickness relative to the remainder of connector arm (806) and the contact plates (803) may comprise tapered elongate edges adjacent to edges of connector plate (801).

### BRIEF DESCRIPTION OF THE DRAWINGS

Embodiments of the electrical power distribution track system will now be described, by way of example with reference to the accompanying drawings in which:

FIG. 1 is an isometric view of the electrical power distribution track system which provides flexibility in the location of a connection adapter/plug;

FIG. 2 is a sectional end elevation of the electrical power distribution track system of FIG. 1 with an adapter connected;

FIG. 3a is an exploded view of a springleaf assembly.

FIG. 3b is an exploded view of an electrical power distribution shuttering system forming part of the electrical power distribution track system of FIGS. 1 & 2;

FIG. 4 is a sectional end elevation of the shuttering system of FIG. 3;

FIG. 5 is a sectional end elevation of the shuttering system of FIGS. 3 & 4 when an adapter is fitted;

FIG. 6a is an isometric view of a track plate which carries contacts in the electrical power distribution track system of FIG. 1;

FIG. 6b is an isometric view of a contact strip to be carried on the track plate of FIG. 6a;

FIG. 6c is an isometric view of a power conductor assembly of the electrical power distribution track system of FIG. 1 comprising the contact strip of FIG. 6b and the track plate of FIG. 6a assembled in an insulating channel;

FIG. 7a is an isometric bottom view of an adapter, such as that shown in FIGS. 1 & 2, when in an “open” position;

FIG. 7b is an isometric bottom view of an adapter, such as that shown in FIGS. 1 & 2, when in a “closed” position;

FIG. 7c is an isometric view of a rotatable electrical connector of an adaptor/plug, showing the slide-in engagement action with a corresponding power contact when the adapter/plug is rotated to a “closed” position;

FIG. 8a is an exploded isometric view of an electrical connector arm of the rotatable electrical connector of FIG. 7c;

FIG. 8b is an exploded isometric view of the rotatable electrical connector of FIG. 7c before a moulded plastic insulation is formed;

FIG. 9a is an orthographic projection (with partial sections) of the rotatable electrical connector of FIG. 7c;

FIG. 9b is an isometric view the rotatable electrical connector of FIGS. 7c & 9a;

FIGS. 10 to 14 is the exploded isometric view of an adapter/plug grounding mechanism in which:

FIG. 10 is a perspective view of the rotatable electrical connector of FIGS. 7c & 9a;

FIG. 11 is a sectional isometric view of an adapter bottom cover showing a safety protector guide;

FIG. 12a is an isometric view of a safety protector;

FIG. 12b is an isometric bottom view the safety protector of FIG. 12a;

FIG. 13a is a section isometric view of an adapter plate to show a ground connector assembly;

FIG. 13b is an isometric view of the second side of the adapter plate of FIG. 13a; and

FIG. 14 is an isometric view an adapter top cover;

FIG. 15 is sectional view showing the adapter/plug grounding and lock-out system during insertion; and

FIG. 16 is a sectional view showing the adapter/plug when the connector is fully inserted through the opening into the cavity in the track and after the bottom arm is permitted to rotate to the “closed” position where it makes electrical connection with the mains conductors.

### DETAILED DESCRIPTION OF THE PREFERRED ELECTRICAL POWER DISTRIBUTION TRACK SYSTEM

Embodiments of the power distribution system described below provide a reliable, effective and inexpensive shuttering solution which is simple and inexpensive to make, such that the product is affordable.

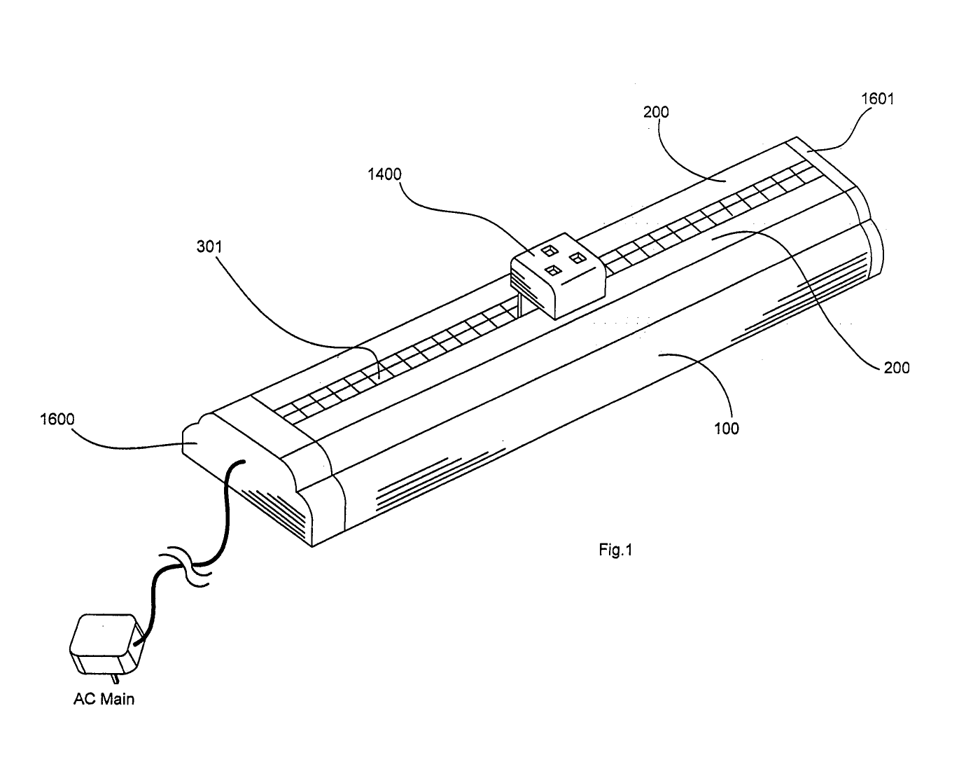

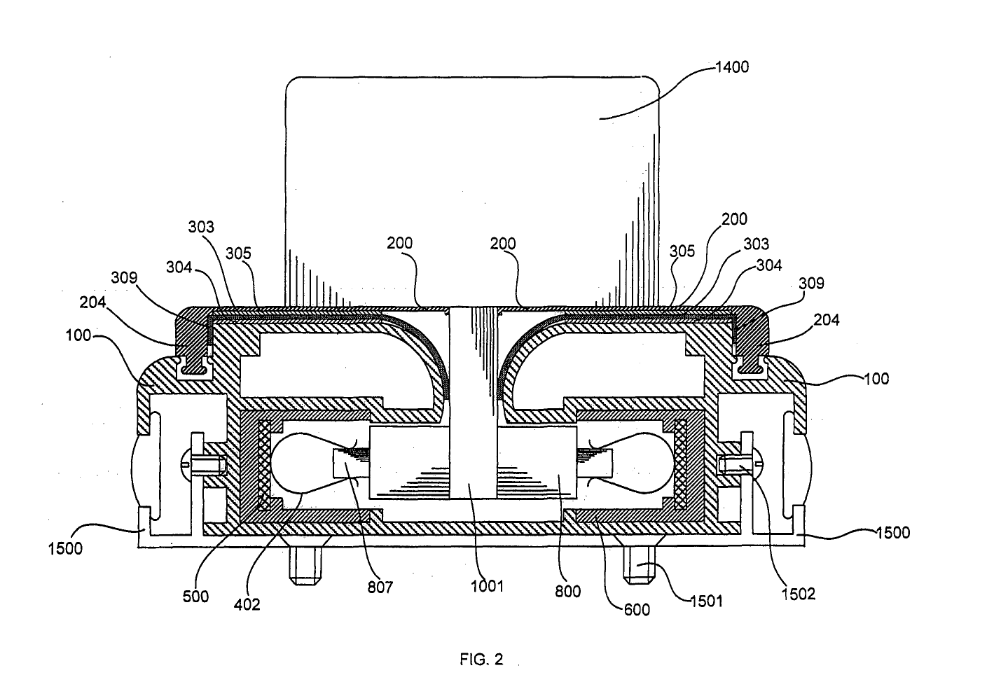

Referring to the drawings, FIG. 1 illustrates a short length of an embodiment of an electrical power distribution track system in its finished form, while FIG. 2 shows a sectional view through the system of FIG. 1. Generally the apparatus comprises an extruded elongate housing (100) with an elongate opening (104) extending along the housing (100), and a shuttering mechanism fitted to the housing (100) to close the elongate opening (104) in locations where, for the time being, connection is not required. Power distribution is provided in the form of a plurality of elongate conductors, which are installed inside the housing (100) along the side walls and the housing is enclosed by two plastic side covers (1600, 1601). Power adapters (1400) which are insertable into the track system can be in the form of a general purpose socket, or a dedicated connection for other electrical apparatus, which is intended to obtain electrical power from the system. The adapters or plugs (1400) can be connected to the system at any point along the elongate opening (104) by being pushed in and rotated to a “closed” position in which the adaptor contacts the elongate conductors.

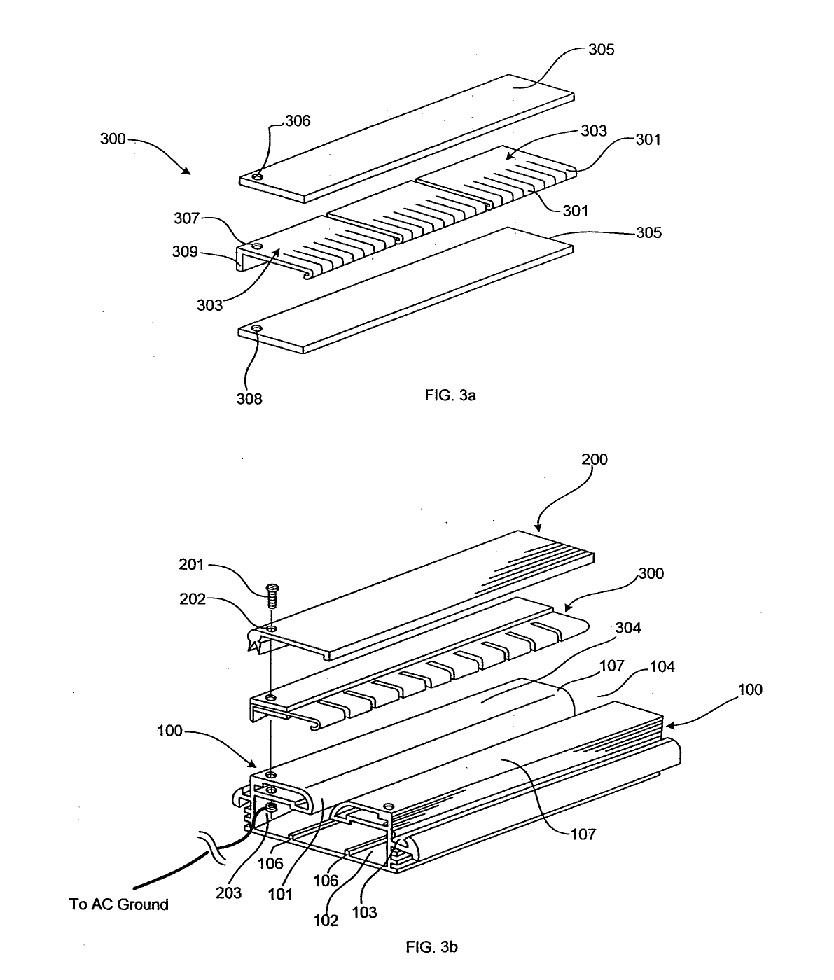

Referring to FIG. 3a, the springleaf assembly (300) is illustrated in greater detail. A springleaf plate (303) is formed of spring steel sheet, pre-cut with slots extending inwardly from one edge and forming a plurality of springleafs (301). The other edge (309) of the springleaf plate (303) is bent at an angle to locate it and to allow it to resist being pulled out when the plug/adaptor (1400) is inserted or removed. One or more springleaf plates (303) may be laminated between a pair of mounting plates (305) which are formed as plastic extrusions, and bonded to the springleaf plate (303) with adhesive layers (304).

Referring to FIG. 3b, the housing (100) and the shuttering system is illustrated in greater detail. The housing (100) is formed by a rigid elongate plastic or aluminium extrusion. In the case of an aluminium extrusion, the housing (100) is coated with insulation coating for protection against the environment. The housing has an elongate opening (104) extending along its length through which the adapters/plugs are intended to be inserted for connection to the conductors. A springleaf profile (101) is formed below the elongate opening with a curved surface arranged to co-operate with the springleaf and having a curvature which is determined by the elastic characteristic of the springleaf to enable each springleaf to bend along the corresponding profile during the insertion of the adaptor/plug and to return to its original shape without deformation when the adaptor/plug is withdrawn. A springleaf assembly mounting surface (107) is formed on each side of the elongate opening (104).

Safety plate grooves (103) extend along each side of the elongate housing to allow the safety grounding plates (200) to slot into each side. Mounting grooves (105) are formed below each of the safety plate grooves (103) to enable the system to be mounted into a mounting base (1500). Compartments (102) are formed on each side of the elongate opening (104) within the housing (100) under the springleaf assembly mounting surface (107). When installed, the safety grounding plate (200) is grounded to the earth of the AC mains supply by a wire connected via a grounding screw (201) and grounding nut (203).

The springleaf assemblies (300) are to be mounted on each of the springleaf assembly mounting surfaces (107) along the length of the housing by adhesive (304).

Safety grounding plates (200) formed as elongate conductive metal extrusions are mounted on top of each of the springleaf assemblies (300) and mounted to the housing (100) by sliding respective connecting portions (204) into each of the safety plate grooves (103).

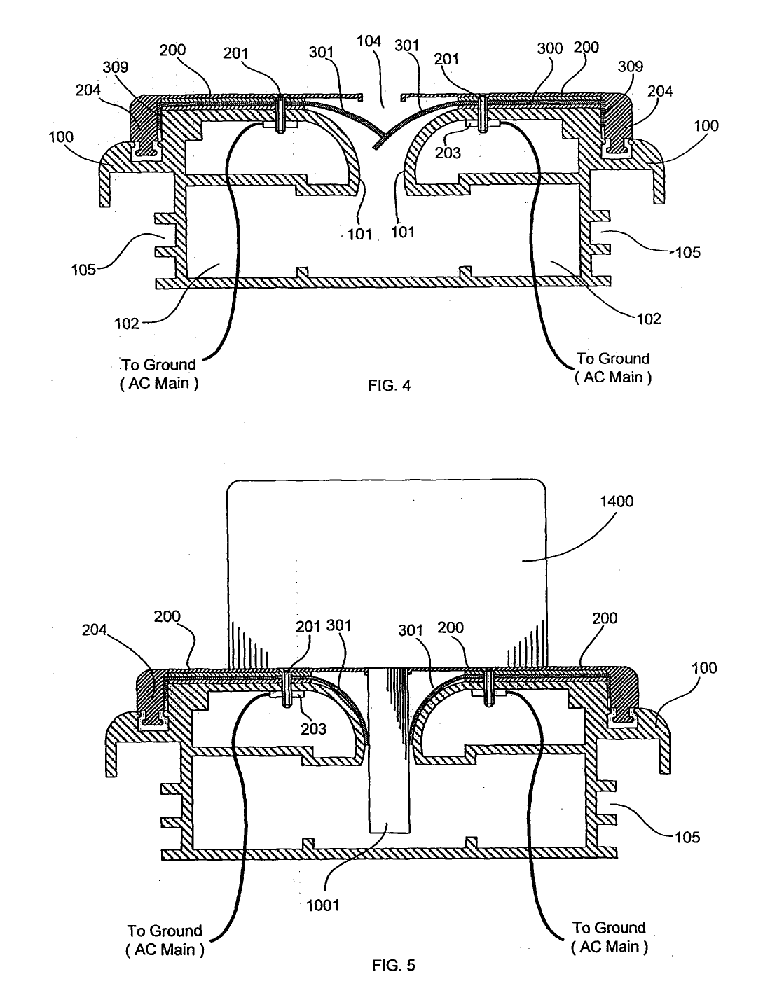

A sectional view of the shutter assembly is illustrated in FIG. 4.

FIG. 5 shows the sectional view of FIG. 4 with an adapter/plug (1400) inserted into the system, such that the springleafs (301) in the location at which the adaptor/plug is inserted are bent along the springleaf profiles (101). When the adapter/plug is removed from the system, the corresponding springleafs will return to the closed configuration in which the elongate opening (104) is covered as shown in FIG. 4.

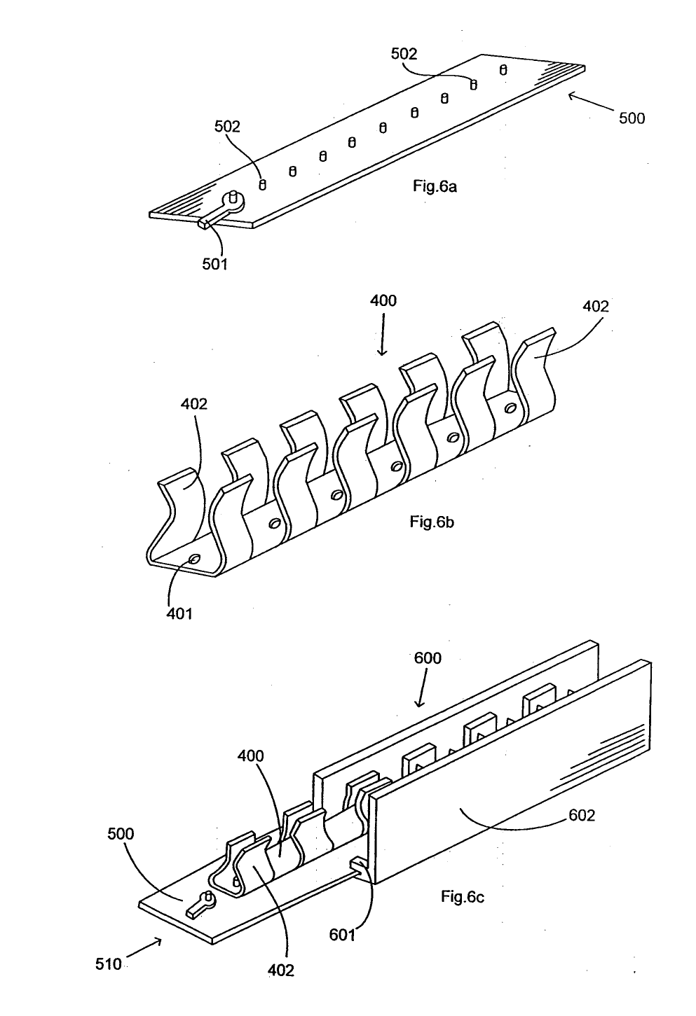

Referring to FIG. 6a, FIG. 6b and FIG. 6c, details of the power conductors are illustrated in more detail. In FIG. 6b a strip (400) of facing contacts (402) is formed from conductive spring sheet material, and is pre-formed with multiple contacts (402) and an alignment hole (401) between each of the contacts. One or more strips (400) of contacts (402) are mounted and electrically connected by conductive rivets (502) onto a track plate (500) as showed in FIG. 6a.

The track plate (500) showed in FIG. 6a is formed from conductive metal plate material and extends for the length of the housing (100). A plurality of conductive rivets (502) protruding from the track plate (500) align and mount the contact strip (400).

In use, connection of one supply line of the AC mains is made to the track plate (500) via the lug (501).

As shown in FIG. 6c, the conductor rail (510) is mounted by sliding into one of the slots (601) in an elongate insulator (602) to form one track assembly (600). The conductor rail (510) is isolated at both ends by insulation spacers (not illustrated). The elongate insulator (602) is formed as an extrusion of insulation material such as a plastics material.

As shown in FIG. 2, the power track assemblies (510) are mounted inside respective compartments (102) the extremities of which are defined by track holder guides (106) in the housing (100). The track assemblies (510) are mounted by being slid into the compartments (102) from one end of the housing (100).

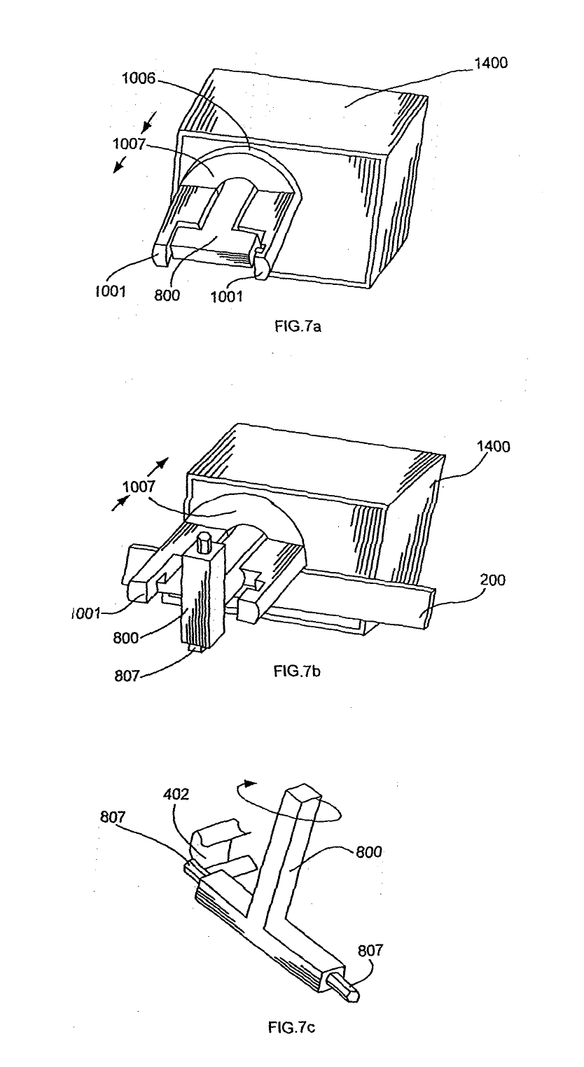

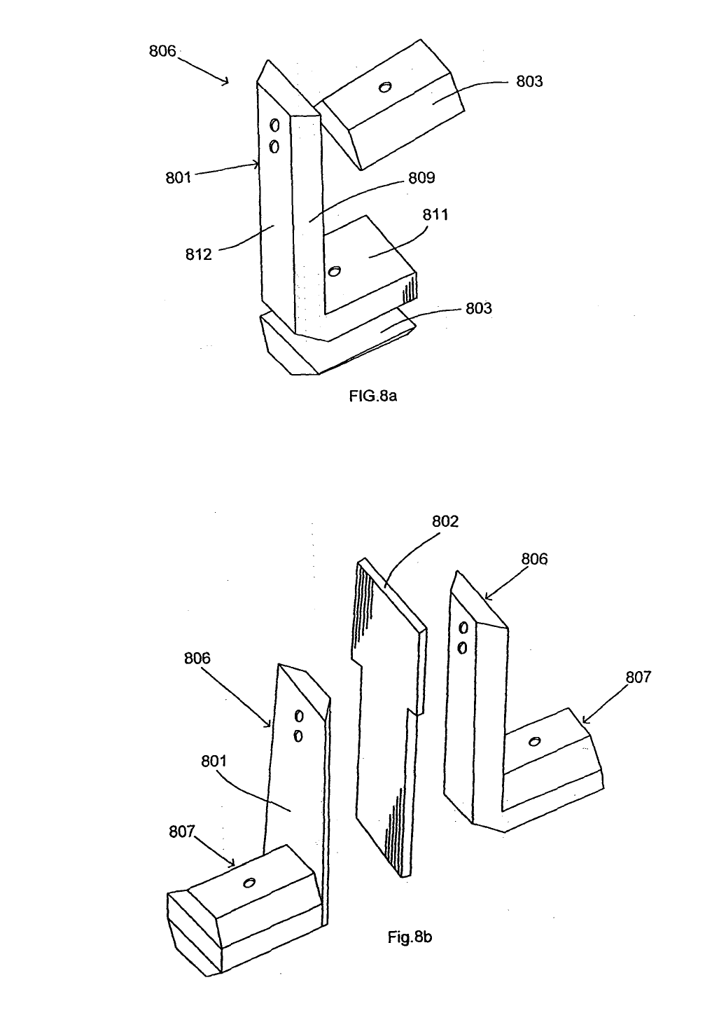

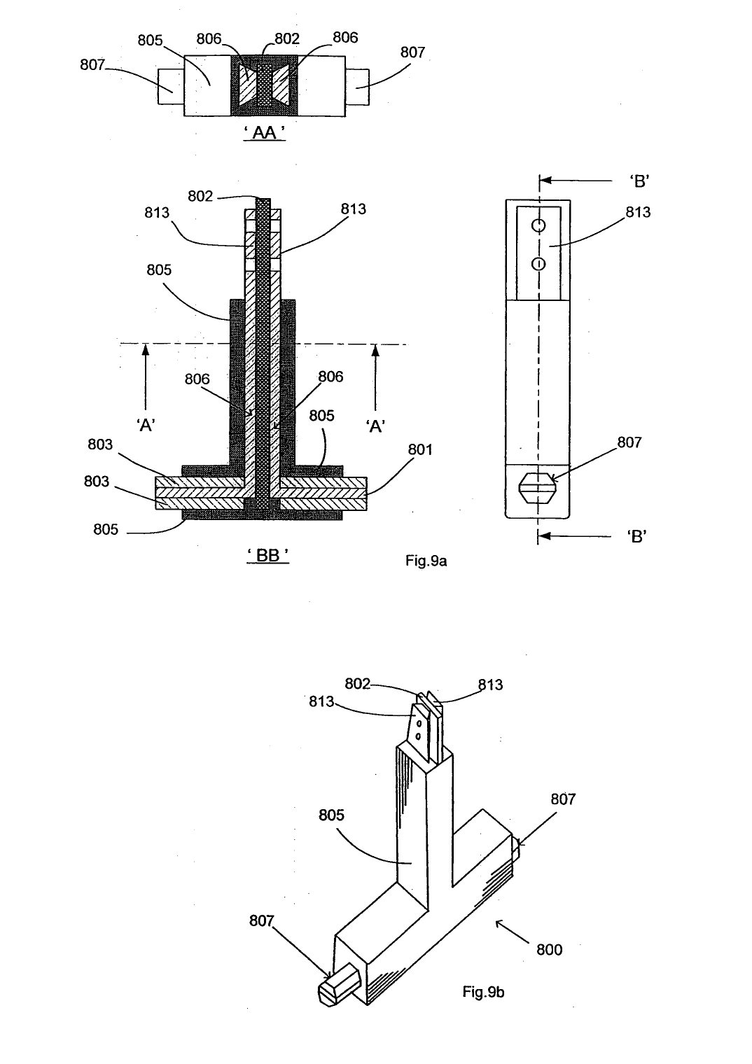

Referring to FIG. 8a, FIG. 8b, FIG. 9a and FIG. 9b, construction of an electrical connector (800) is illustrated. Connector arms (806) seen exploded in FIG. 8a comprise a connection plate (801) formed from conductive metal plate material with elongate tapered edges (809) (to improve the electrical dielectric strength of the connector (800)) and then bent into an “L” shape to form an arm having a shorter portion (811) extending from the broader surface of a longer portion (812). Contact plates are formed from conductive metal material with tapered elongate edges (to enable a smooth slide-in into the corresponding contacts (402) during the rotation to a “closed” position as illustrated in FIG. 7b, and are mounted and electrically connected to the shorter portions of the connector arms (806) to form contact portions (807). A connector insulator (802) comprises a sheet of insulation material having a high dielectric strength (sufficient to meet an electrical safety standard for AC mains power distribution systems) as shown in FIG. 8b. Two connector arms (806) are laminated together with the smaller surfaces of the longer arms (812) facing each other, and isolated by the connector insulator (802) as showed in FIG. 8b. As illustrated in FIG. 9a and FIG. 9b the assembly is then insulated by moulded plastic (805) with the contacts (807) and external connection points (813) remaining exposed for connection requirements.

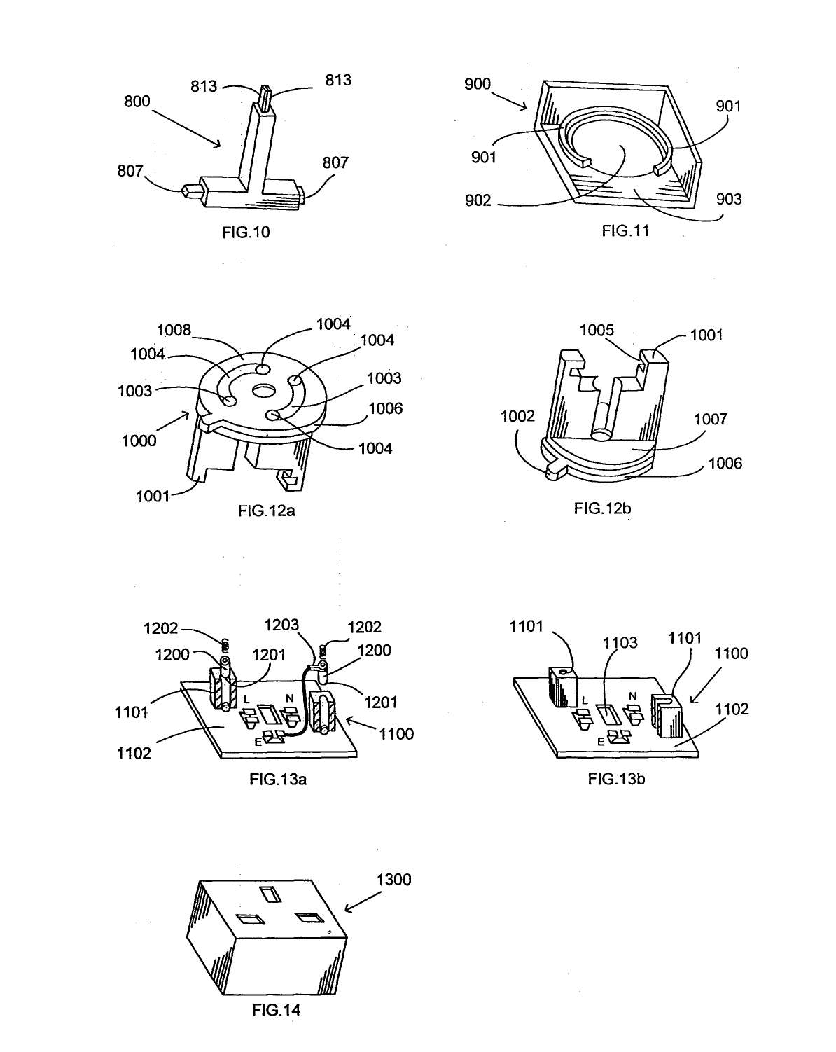

Referring to FIGS. 10 to 14, the adapter/plug (1400) is illustrated in detail and shows parts comprising a grounding system. The safety protector (1000) shown in FIG. 12a and FIG. 12b is formed from conductive metal and comprises a round rotatable plate (1006) with a centre hole, two grooves (1003) formed on a top or internal surface (1008) at a designed radius to allow the ground connector (1200) and ball contact (1201) to travel inside the grooves (1003) under the pressure of a spring (1202) during the rotation from the “open” position to “close” position. Four detents (1004) formed at the end of the grooves (1003) provide a spring holding force and a “click” feel and sound indication at the “open” and “close” position. A bottom cover (900) of the adapter is illustrated in FIG. 11, and is formed as a moulded plastic piece with a opening (902) and a safety protector guide (901) which allows the safety protector (1000) to be seated inside with its limbs (1001) extending from the opening (902). The safety protector guide (901) has a gap (903) to limit the travel of a stopper (1002) to rotate only within the gap (“open” position to “closed” position). Two limbs (1001) extend from an exposed or external surface (1007) of the round rotatable plate (1006) to engage the springleafs (301) when the adapter is inserted into the track system.

The adapter plate (1100) shown in the FIG. 13a and FIG. 13b is formed as a plastic moulding comprising two connector blocks (1101) extending from a plate (1102) with a centre hole, to allow the ground connector (1200) and ball contact (1201) to be seated inside the centre hole. The ground connector (1200) shown in FIG. 13a is formed of conductive metal with the hemispherical shaped ball contact (1201) on the bottom end for contact to the grooves (1003) in the round rotatable plate (1006), and a tab (1203) at the top end for connection to a ground clip of the adapter/plug (1400) by a wire shown in FIG. 13 connecting between an earth contact (E) on the electrical outlet and the tab (1203) on the ground connector (1200). An adaptor top cover (1300) shown in FIG. 13 is formed as a plastic moulding and serves to provide guide holes for a plug, as well as holding down the spring (1202) and enclosing the adapter/Plug contact parts. The adapter top cover (1300) is attached to the bottom cover (900) by integrally moulded clips (not shown).

When an attempt is made to insert an adapter/plug (1400) into the electrical power distribution track system, the exposed surface (1007) of the adapter/plug (1400) is grounded by contact with the safety grounding plate (200).

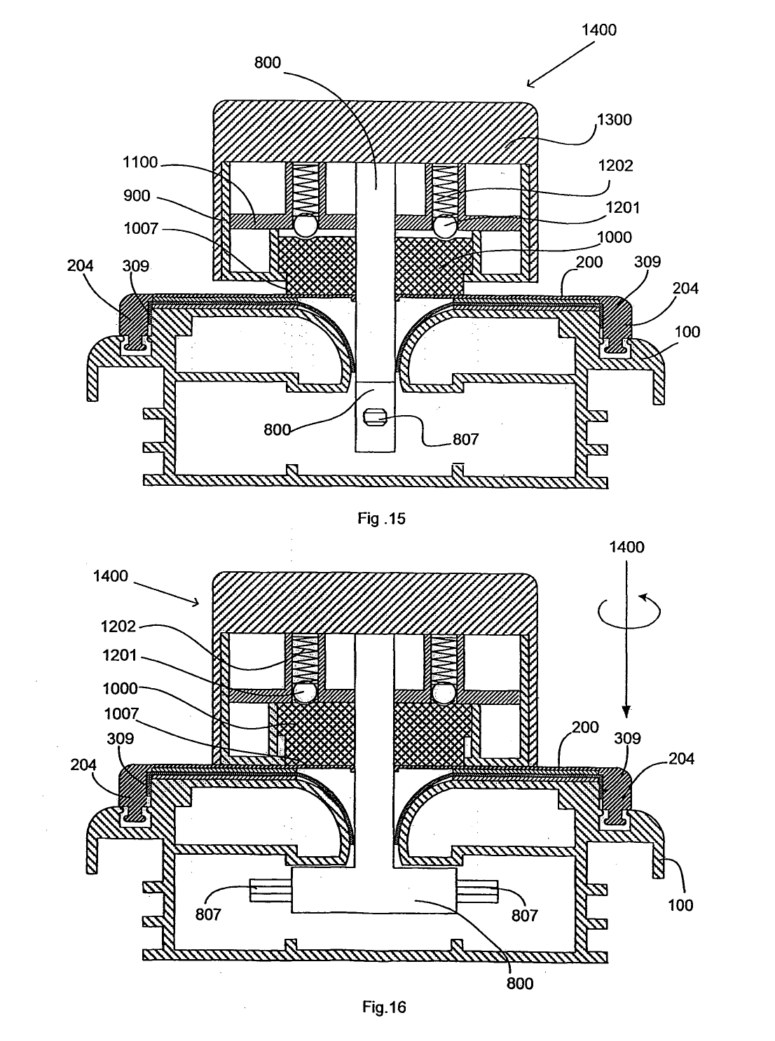

Referring to FIG. 15, the grounding system of the adapter/plug (1400) is illustrated with the adapter/plug (1400) is partially inserted into the opening (104). The safety protector (1000) is being pushed down by the springs (1202) and the exposed surface (1007) projects out from the bottom cover (900). The bottom arm of the connector (800) is not fully inserted through the opening (1004) and the adapter/plug (140) is thereby prevented from rotating to “closed” position thereby providing a lock-out function.

Referring to FIG. 16, the grounding system of the adapter/plug (1400) is illustrated when the adapter/plug (1400) is fully inserted into the opening (104) and the connector (800) is rotated into the “closed” position. The safety protector (1000) is pressed back into the bottom cover (900) through contact with the safety grounding plate (200) such that it provides a firm grounding to the adapter/plug (1400) via the strong contact of the exposed surface (1007) of the rotatable plate (1006) with the safety grounding plate (200), and the bottom arms of the adapter/plug (1400) are now fully within the cavity and free to rotate into the “closed” position.

Referring to FIG. 7a, an adapter/plug (1400) is shown in an “open” position, while FIG. 7b, shows an adapter/plug (1400) in a “closed” position.

Referring to FIG. 2, an adapter/plug (1400) is shown inserted into the track system and in the “close” position. The mounting base (1500) formed by a metal extrusion extending the length of the housing (100) comprises a plurality of mounting holes which enable it to be mounted onto a wall with fastening screws (1501). The housing (100) is then placed into the mounting base (1500) and secured by screws (1502) which are screwed into the mounting groove (105). End caps (1600) press into the ends of the housing 100 and are held in place by screws (not shown).

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. An electrical power distribution system comprising:
i) an elongate housing;
ii) an elongate opening through a surface of the housing, the opening intended to allow an adapter/plug to be inserted into the housing in use;
iii) a plurality of power conductor contacts located within the elongate housing, the power conductor contacts adapted to connect to a connector arm of the adapter/plug;
iv) one or more springleaf assembly mounting surfaces extending longitudinally of the elongate housing;
v) a resilient elongate springleaf assembly mounted onto the housing on each springleaf assembly mounting surface and extending to cover the elongate opening.

2. The electrical power distribution system as claimed in claim 1 wherein a springleaf profile is formed adjacent to the elongate opening, between the elongate opening and each springleaf assembly mounting surface, the springleaf profile curving into the opening and having a curvature matched to an elastic characteristic of the springleaf.

3. The electrical power distribution system as claimed in claim 1 wherein each resilient elongate springleaf plate is divided into a plurality of springleafs by slits extending from an edge of the springleaf plate.

4. The electrical power distribution system as claimed in claim 1 wherein a conductive elongate safety grounding plate is mounted over the springleaf assembly and in use provides a grounding connection for an adapter/plug.

5. The electrical power distribution system as claimed in claim 1, wherein the plurality of power conductor contacts are formed from conductive spring material and
are mounted and electrically connected to each of two or more elongate conductive track plates, and the electrical power distribution system further comprising:
i) two or more elongate insulated track holders into each of which one of the conductive track plates and the respective mounted contacts are assembled; and
ii) two or more elongate compartments formed in the housing adjacent to the elongate opening, each of the assemblies of the elongate insulated track holders the conductive track plates and the respective mounted contacts being mounted into one of the compartments, there being one compartment and one assembly of an elongate insulated track holder, conductive track plate and respective mounted contacts for each electrical phase to be delivered via the electrical power distribution system.

6. The electrical power distribution system of claim 5 wherein the contacts are formed as an elongate contact strip from which the contacts project.

7. The electrical power distribution system of claim 5 wherein each track holder is formed from an extrusion of an insulating plastics material.

8. The electrical power distribution system of claim 5, wherein the power distribution system is arranged such that in use an electrical connector of an adapter/plug can be inserted through the elongate opening in the housing and rotated from an “open” or disconnected position to a “closed” or connected position in which the connector engages with respective ones of the contacts to enable power supplied to the contacts after installation to be delivered to the adapter/plug, electrical connector comprising two exposed contacts each located at an end of a respective arm arranged to form an electrical connection with a corresponding contact by sliding engagement during the rotation to the “closed” position.

9. An adapter/plug for connection to the electrical power distribution system as claimed in claim 1, the adapter/plug comprising a rotatable connector arm for connection to the power conductor contacts when inserted into the elongate opening past the springleaf assembly, and a conductive safety protector configured to ground the adapter/plug when the rotatable connector arm is inserted into the elongate opening, the safety protector comprising a projection, whereby in use, a surface of the projection or a surface of the connector arm abuts against the springleaf assemblies to depress a portion of the springleaf assemblies, exposing the elongate opening to allow access of the rotatable connector arm to the power conductor contacts.

10. The adapter/plug of claim 9, wherein the connector arm includes a connection plate being formed from conductive material and having a tapered edge to increase an electrical dielectric strength of an assembly containing the connector.

11. The adapter/plug of claim 10 wherein the connector arm comprises one or more contact plates formed of conductive material and attached to the connector plate to form a contact having an increased thickness relative to the remainder of connector arm.

12. The adapter/plug of claim 11 wherein the contact plates comprise tapered elongate edges adjacent to edges of connector plate.

13. The adapter/plug as claimed in claim 9, further including a grounding system comprising:
i) a bottom cover of the adapter/plug;
ii) a safety protector guide projecting from the bottom cover and extending around an edge of an opening therein;
iii) the safety protector being seated in the safety protector guide and being able to rotate therein between an “open” and a “closed” position, the safety protector being formed of conductive material and comprising a round rotatable plate located in the protector guide, the round rotatable plate having a centre hole, at least one rotatable groove formed on an internal surface of the round rotatable plate; and wherein the projection comprises at least one limb extending from an exposed surface of the round rotatable plate opposite the internal surface;
iv) a ground connector and ball contact which travels in the groove during the rotation from the “open” position to “closed” position;
v) an adapter plate seated on the safety protector inside the bottom cover, the adapter plate having connector block having an opening in which the ground connector and ball contact are located and the ball contact being biased into contact with the groove by a spring.

14. The adapter/plug of claim 13 wherein the safety protector comprises detents at each end of the groove to produce a indication sound and provide retention when the safety protector is rotated to the “open” or “closed” position.

15. The adapter/plug of claim 13 wherein the adapter/plug is inserted into the opening of the electrical power distribution system in use, and the external surface of the rotatable plate of the adapter/plug is grounded by contact with an earthed safety grounding plate of the electrical power distribution system during the insertion of the adapter/plug into the opening.

16. The adapter/plug of claim 13 wherein the safety protector is movable and is biased to project from the bottom cover by the spring such that one surface projects from the bottom cover.

17. The adapter/plug of claim 13 wherein the adapter/plug is inserted into the opening of the electrical power distribution system in use, and the adapter/plug is prevented from rotation until a surface is pressed toward the bottom cover to allow the rotatable connector arm to be fully inserted whereby the bottom arm of the rotatable connector arm has passed through the opening into a cavity in which it may freely rotate.

18. The adapter/plug of claim 13 wherein said safety protector guide includes a gap in which a stopper projecting from the safety protector is located to prevent rotation of the safety protector beyond the “open” and “closed” positions.

19. The adapter/plug of claim 13 wherein after the adapter/plug is rotated to the “closed” position, the adapter/plug returns to a resting position such that the rotatable connector arm firmly contacts the power conductor contacts.
